(19) United States
(12) Patent Application Publication
(10) Pub. No.: US 2015/0310516 A1
(43) Pub. Date: Oct. 29, 2015

(54) Method And Apparatus For A Commercial System Designed To Facilitate Buyer Event Driven Commerce Without Need For a Constant Internet Connection

(71) Applicants: Stanislaw M. A. Lewak, Ankorage, AK (US); Jerzy Lewak, Del Mar, CA (US)

(72) Inventors: Stanislaw M. A. Lewak, Ankorage, AK (US); Jerzy Lewak, Del Mar, CA (US)

(21) Appl. No.: 14/261,414

(22) Filed: Apr. 24, 2014

(51) Int. Cl. G06Q 30/06; G06Q 20/40; G06Q 10/00

(52) U.S. Cl. CPC G06Q 30/0609; G06Q 10/20; G06Q 20/40; G06Q 30/0635

(57) ABSTRACT

Methods, supported by a computer system and practiced by a facilitator, are described which facilitate the procurement of equipment, supplies, services and information by any user. The methods comprise the use of current and new technology to support the initiation of orders for equipment, supplies, information, and services over the internet, but without the need for an internet connection at the time of initiating the order. The methods also comprise a plurality of possible sources of revenue for the facilitator, as well as providing value, savings of effort and time for the user. Users can be, for example a homeowner maintaining a home or a number of homes or apartments, a sailor maintaining a boat, or more generally any user of a vessel, a vehicle, or a spacecraft.

### CROSS REFERENCE TO RELATED APPLICATION

This application claims the benefit of the filing of U.S. Provisional Patent Application No. 61/815,506 filed on Apr. 24, 2013, the disclosure of which is incorporated by reference herein.

### BACKGROUND OF THE INVENTION

The methods described here are applicable to any kind of user, although some applications may be more fruitful than others. A user here is understood to mean any person using the provided methods and where the context allows, a user could also be a computer system, or any computer program using the methods and systems. A practitioner providing or making available these methods and systems to users will be referred to as a facilitator.

As one example of possible application of these methods, travelers using vessels or vehicles of any kind need supplies and services and often do not have a connection to the interne and so will find the described features offered by a facilitator very useful. Practitioners of the art will see the applicability of these methods to many other types of users. For example, anyone can use the system to maintain a home, and all associated tasks and supplies of goods and services.

Users require a number of supplies and services, most of them on a continuing basis, some for maintenance, security, and insurance, while others for replacing consumables or items that expire. Suppliers of these are most commonly in fixed locations, not always conveniently accessible the user. Some travelers using land based vehicles can travel to suppliers, such travel is often impractical or inconvenient. This is one reason why such supplies and services, particularly for travelers using vessels, are not always competitively priced. When travelers arrive at a location where such supplies and services are available they may be inevitably induced to purchase their needs at almost any price they can afford.

Methods of using, currently existing and to be developed, computer related technologies, both hardware and software, can be utilized to make the maintenance of a vessel or home, its consumable supplies, information needed, and other services, very conveniently accessible. It is an objective of this invention to make such methods convenient for the user, the vendor, and a source of profitable revenue for the facilitator.

For convenience the descriptions here use a vessel as the example on which the methods can be used, however many of these methods are also applicable elsewhere, such as for example, in the home, on the road, in any environment which limits physical access to commerce. These examples are not meant imply any limitation of applicability.

Vessel upkeep requires periodic replacement of certain supplies, for example: flares on a boat. It also requires other periodic actions to be taken. For example, the vessel needs to be periodically checked, re-supplied, preventative maintenance scheduled and done, insurances and registration renewed, and other appropriate actions taken. The methods described here envision products which provide reminders to users of such needed actions and can keep a complete log of all actions taken, products purchased, and if authorized by the user, place orders automatically.

Travelers often need information such as maps, weather conditions, wind and current directions etc. Information also needs to be kept current. Insuring the currentness of information is one of the services which needs to be provided. Such actions can be helped by the facilitator.

Many of these needs are also the needs of a homeowner, although they may not be as demanding as for example, those of a user sailing a vessel.

### BRIEF DESCRIPTION OF THE FIGURES

FIG. 1 is a flow chart of the principal steps that can control setup the order system.

FIG. 2 is a flow chart of the steps that can control the order client.

FIG. 3 is a flow chart of the steps that can control the order server.

### DETAILED DESCRIPTION

Methods which can be employed by a facilitator to provide for the needs of users, comprise one or more of the following:
1. Provide a computer based system and a web based service, which will benefit a user (for example: on a vessel, in the home, in the office or anywhere needed) and the vendor or service supplier, for example, by:
   automating certain required scheduled tasks;
   providing reminders of scheduled tasks;
   providing and insuring up to date information;
   providing timely and convenient, access to products and services;
   allowing users to get bids from vendors to supply services or goods.
   providing convenient methods of scheduling appointments with vendors of products or services, and viewing scheduled appointments.
   providing access to technical support;
   providing ability for a user to initiate orders for goods or services, or appointments, during the absence of an internet connection;
   providing access to data containing current information needed by the user;
   providing an opportunity of shared forums for users and vendors, allowing vendors to help users, and vendors to work together;
   providing tools for managing business tasks of a vendor;
   providing a user an opportunity to rate each vendor, or service;
   providing a vendor with feedback by users of the quality of products and services.
2. Enter into agreements with vendors of products and services which a user might need, the agreements providing for sales based payments by the vendor to the facilitator and optionally offering discounts to the facilitator supported user.
3. Offer opportunity for paid advertising by vendors.
4. Establish and offer a topical publication with news of likely interest to a user.
5. Collect data from a vessel and when connectivity and bandwidth are available, upload to a central server, or allow option to hand carry collected data via a portable memory device to a computer connected to a network that has access to the central server.
6. By agreement with a vendor, arrange, through a central web based server, or by other means, to update the data stored on a computer system accessible by the user even when an internet connection is not available to the user, about products, prices and their availability. Such updates can be made automatically by a web based server when internet service is available. Alternatively, the user may obtain the data on a portable data storage device or other media.

Such an intervention, through the use of computers provides an opportunity for the use of currently available technology, optionally enhanced with new software and hardware, to provide benefits to the user, numerous opportunities to vendors, and a profitable business to the facilitator.

### Methods of Initiating Orders: Event Driven Commerce

A monitoring system, monitoring and recording all potentially useful events, or instrument readings, can be built from existing hardware and software. It can comprise one or more computers running one or more software programs. Such a system may record the collected data in one or more files.

Collectively we will refer to these files in the singular, as a LogFile. On a vessel, it will hold a collection of gathered data from vessel instruments, such as for example: location, speed, wave conditions, and so on. Additionally it can maintain the inventory and maintenance databases, optionally with the status of each product or equipment, such as for example, when the product was purchased and when the product needs to be replaced, or when the product was used. A software program, referred to here as an event creator monitors the contents of the LogFile, any events created by installed equipment or not recorded in the LogFile, or any calendar based user settings.

When an event, which requires an order action, is encountered, the event creator communicates a corresponding action to an order client and optionally to the user. The order client is configured to accept the respective communicated action and to convey the order automatically to a central server, if an internet connection is available. If an internet connection is not available, the order client initiates the order and completion is accomplished when the order is delivered to the central server, either by an order client using a subsequent connection to the internet, or by any other means.

An electronic calendar software program, of which several are available on the market, with a suitable API for sending event signals to a program, can be arranged to be a calendar driven event creator, which can also be made a part of a program comprising other functionalities described here.

During the absence of a connection to the internet, a computer software program can initiate orders for services and products. When the internet is available, or conveying the order on a portable data storage medium to the order server. Such a computer program will be referred to as an order client, running on a computer system, and communicating with a web accessible server referred to here as the order server.

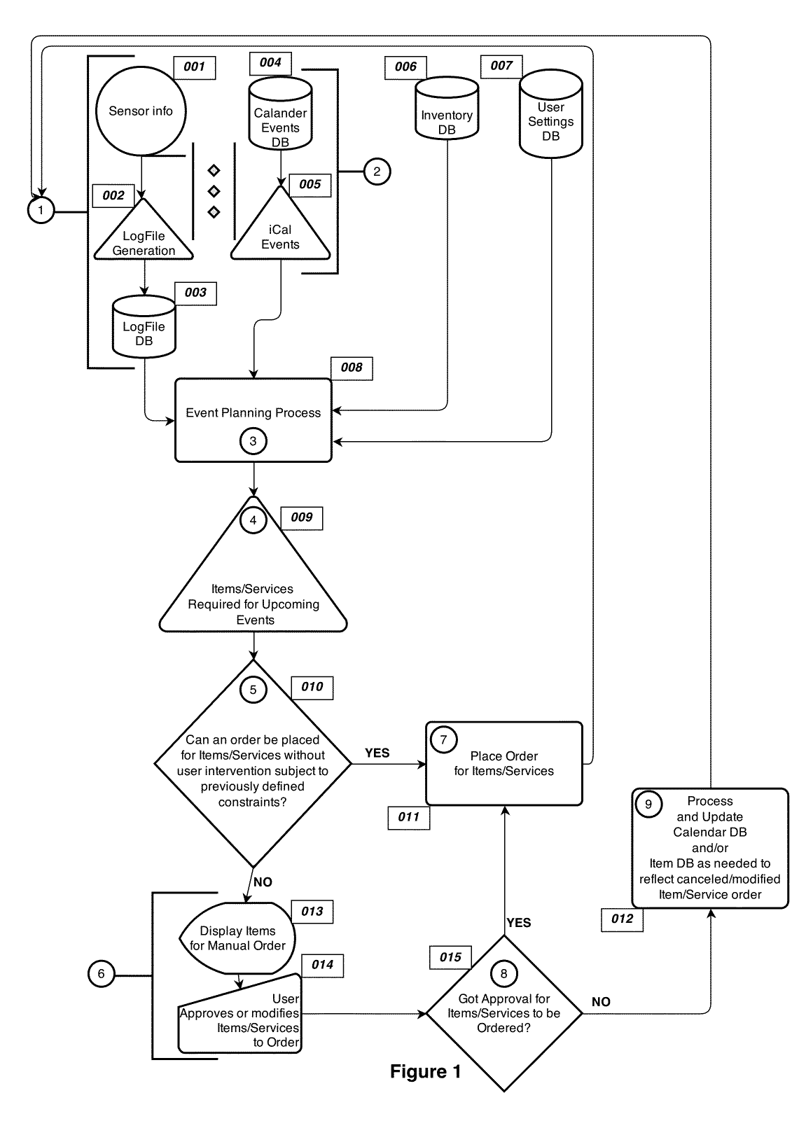

The following are the main first steps or their functional equivalent, performed by the order server and order client. Steps ands, may be performed in parallel:
1. Data is collected from Sensors and put into the LogFile. FIG. 1 [001].
2. The Calendar Events data file is accessed checking for upcoming events. FIG. 1 [002].
3. The Event Planning Process takes in upcoming events and prepares a list of items and services that are needed for successful completion of the upcoming Events. FIG. 1 [003]
4. The Event Planning Process compares these items with items on hand and generates a list of items that need to be ordered and services that need to be scheduled to allow timely and successful completion of upcoming events.
5. For each item/service in the list, if an automatic order can be placed for the item/service go to step 7. FIG. 1 [010].
6. The user is presented with a list of items/services which must be dealt with manually. The user can cancel/modify the event that triggered the item/service, or can accept the ordering/scheduling of each item/service. If necessary the list may now be split into 2 sublists:
   Approval list: consisting of items/services that have been approved by the user. This sublist is processed in step 8. FIG. 1 [014].
   Cancel/Modify list: consisting of items/services that have had their driving event cancelled or modified (for example: postpone engine service). This sublist is processed in step 9. FIG. 1 [013].
7. Each item/service that is in the passed list is ordered/scheduled taking into account the present vessels location, as well as the expected itinerary. Go to step 1. FIG. 1 [011].
8. The Cancel/Modify list generated in step 6 is sent to step [Referenced content is missing.]. FIG. 1 [015] and [012].
9. Process and update calendar DB and/or item DB as needed to reflect canceled/modified item/service order. FIG. 1 [012].
10. Return to step 1.

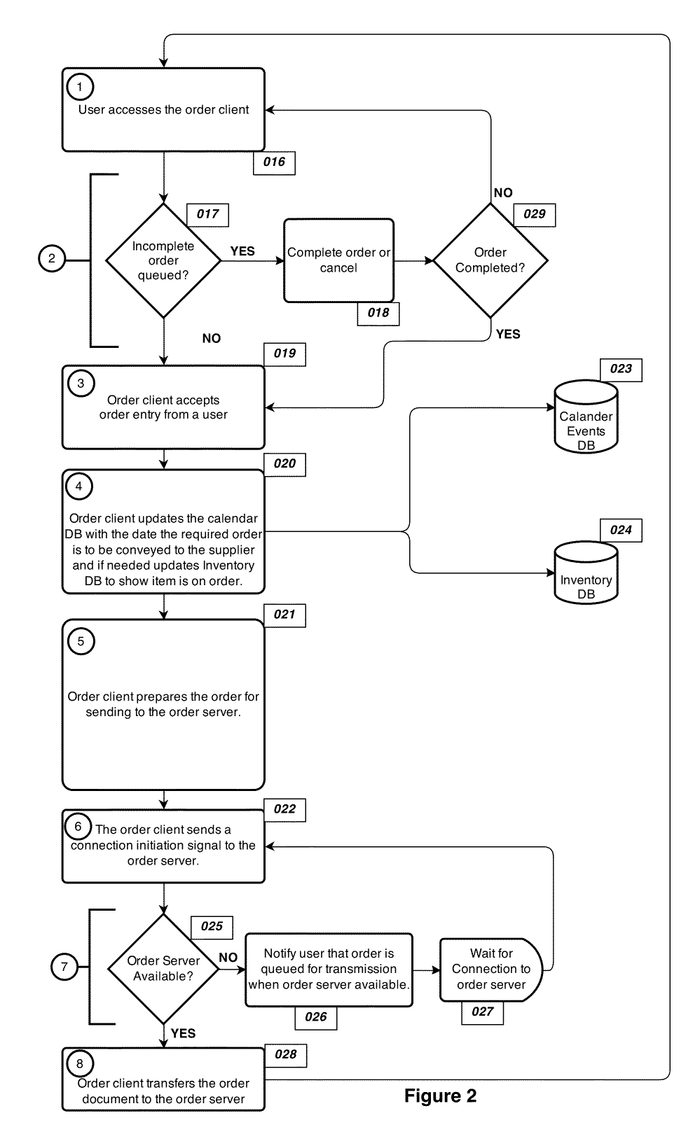

When a user wants to enter an order the following main steps or their functionally equivalent are executed:
1. The user accesses the order client and checks for any problem orders. FIG. 2 [016].
2. If an alert of an incomplete or problem order is showing, the user can complete the order or cancel it. FIG. 2 [017], and [018].
3. The order client accepts an order entry from a user. FIG. 2 [019].
4. The order client updates the calendar DB with the date the required order is to be conveyed to the supplier and if needed updates Inventory DB to show item is on order. FIG. 2 [020].
5. When an order signal is communicated to the order client by the event creator, it is converted to the corresponding required completed electronic order ready for sending to the order server. FIG. 2 [021].
6. The order client sends a connection initiation signal to the order server. FIG. 2 [012].
7. If the connection signal is not responded to by the order server within a time-out period, it is assumed the connection is not available and the user is notified that the order will be transmitted to the order server when a connection is available. At this point other software or hardware can be used to notify the order server when a connection is available. Alternatively, the order client can periodically check for a connection. Either, after a pause, or when notified that a connection is available, step 6 is repeated. FIG. 2 [025], [026], and [027].
8. If the connection is responded to, the order client transfers the order document to the order server queue and returns to step 1. FIG. 2 [028].

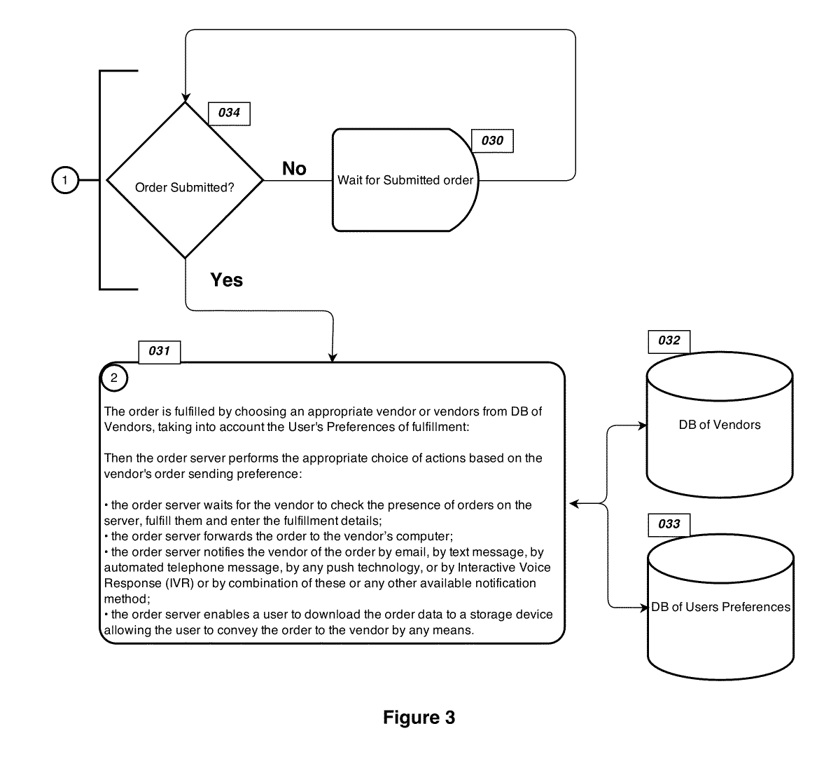

The steps performed by the order server are:
1. The order server checks if an order has been submitted to be processed. If there is no order submitted, the server waits a short period of time and repeats the checking for order. FIG. 3 [034].
2. The order is fulfilled by choosing an appropriate vendor or vendors from a database of Vendors, taking into account the User's Preferences of fulfillment. (FIG. 3 [031].) Then the order server performs the appropriate choice of actions based on the vendor's order sending preference:
   the order server waits for the vendor to check the presence of orders on the server, fulfill them and enter the fulfillment details;
   the order server forwards the order to the vendor's computer;
   the order server notifies the vendor of the order by email, by text message, by automated telephone message, by any push technology, or by Interactive Voice Response (IVR) or by combination of these or any other available notification method;
   the order server enables a user to download the order data to a storage device allowing the user to convey the order to the vendor by any means.
3. Order server returns to step 1.

When placing an order to a vendor the system can enable the user to refer to a database of vendor products and services. Initiating orders when an internet connection is not available can use a database of vendor products and prices located on a user accessible computer and kept current by being automatically updated when an internet connection is available, or by obtaining the data by any means available to the user, for example, on portable storage media, such as a flash plug and transferring the data to a user accessible computer.

The placing of an order can be preceded by a notification to the vendor before the need of the order's fulfillment. Such a notification can be made automatic and can include a reminder to the user of its imminence. The automatic notification can be performed through a setting provided in the order client, but remembered and executed by the order server. Of course it can alternatively be implemented by a separate system. The reminder to the user can be performed by an application running on the order server, or by the order server itself. In situations where the local computer cannot connect to the internet, it can be performed on the local computer used by the user or by a continuously running order client or by a local server. The automatic order option which can be housed on the order server computer, will have the advantage of being almost always on the internet and therefore able to communicate to the vendor, the order and order notification, without appreciable delays and independently of user's connection to the internet.

### Application Examples

It is assumed that the vessel has components of a computer system on board which can connect to the Internet if a connection is available, but a connection is not assumed and need not be available for most or even all of the time. When a connection is not available the user can obtain or deliver any information, needed to perform the described tasks, on portable storage media.

The following examples illustrate some of the detailed products and services which can be provided by a facilitator to a user using the methods described here, with the associated possible sources of revenue to the facilitator. These examples are not meant to limit the use of these methods in any way.
1. By user intervention or by prior setup, the ordering of needed supplies, inventory, certain maintenance actions, can be automated. The need for other maintenance actions can be communicated to a user.
2. A facilitator can offer a subscription service to update items of information stored on a local computer. Updating can be done automatically when the computer is connected to the internet or by other means when it is not.
3. Revenue to facilitator through arrangements with suppliers of items needed by the user. For example:
   a. A referral fee paid by vendor to facilitator based on sales of parts, supplies and services purchased by user.
   b. Sale of advertising space to be displayed during user access.
   c. Referral fees from service providers collected as follows:
      i. User orders a service by scheduling an appointment from a listed service provider either when an internet connection is available or using a satellite or SSB (single side-band) connection;
      ii. Appointment confirmed by service provider through an internet server;
      iii. User pays facilitator over the internet, which allows user to rate service provider;
   d. The following are possible vendor motivations:
      i. Vendor will be motivated to pay facilitator's referral fees in order to obtain a rating for vendor's service; and to stay listed in facilitator's database.
      ii. User will be motivated not to by-pass the referral fee because by-passing it would destroy user's maintenance record and not allow user to make use of other services which may be offered by a facilitator, such as dispute mediation with the vendor, special trade insurance arranged by facilitator with the vendor.
   e. Selling of data (anonymous or by user's permission) about customers to service providers, for example insurance companies.
4. Automatically and by user intervention, enabling a maintained up-to-date inventory database of parts and supplies, which contains data about:
   a. Location on vessel or in the home, of items;
   b. Date of expiration of relevant items;
   c. Cost and supplier of each item when ordered;
   d. Dates of each maintenance events, past, present and future;
   e. Dates of any planned or required events. For example: insurances and registration renewals.

### Product Warranties, Insurances, and Navigation Data

Many of these methods are applicable generally to all warranties and insurances although their application to travelers and their needs is perhaps the most beneficial. Some of these methods may not be as useful for warranties and insurances of low valued products as they would be for high-valued products, such as boats and the associated equipment.

It is thought that there are about 2,768,354 boats of length between 28 and 49 ft in the world. Although this is probably an underestimate because large numbers of vessels are not registered, it is also certainly only a fraction of all vessels. It is an objective of this invention to describe electronic and procedural methods and systems that can be used by any vessel users to collect many types of data about the vessel and its experiences while sailing Another objective of this invention is methods of making the collected data available to others. A further objective is to enable the use of the collected information to help users of purchased equipment obtain best possible insurance rates and to maintain validity of warranties of purchased equipment.

The following are some examples of the kinds of information which can be collected by vessels:
1. Details of the vessel such as:
   draft
   beam
   type
   length, etc.
2. Vessel logs collected electronically including:
   Places and times visited and any sailing events of interest and usefulness;
   Vessel maintenance records;
   Details of new or replacement equipment purchased;
   Any encountered accidents and their causes.
3. Data for oceanographic research collected automatically by instruments currently available, during sailing, such as records of:
   Depth;
   Wind;
   Waves;
   Current;
   Sailing speed;
   Vessel position;
   Universal time;
   Noted sailing hazards;
   Details of weather.

There are many places in the world which are regularly visited by vessels, but for which there is no reliable and complete information about such data as depth and hazards, whether submerged or not. Vessels using the methods described here would be able to collect such data and through a sharing with others, enabled by a facilitator, help chart many unchartered waters and prevent accidents.

Collected detailed logs of operation and usage of the vessel, vehicle, or equipment (generally equipment) can provide information to an insurance company enabling them to offer better insurance rates to a safer user. An objective of this invention is to make agreements with insurers by which an insurer will accept the relevant data collected by a vessel or vehicle and determine by its content the best premium they can offer the customer. For customers whose maintenance and operations data shows compliance with instructions and good judgement, the agreement could require the insurance vendor to offer discounts from their usual rates.

Collection of relevant data would not require any connection to the interne. Collected data could be stored locally, on board a vessel, vehicle, or equipment, and uploaded, emailed or delivered some other way, to the facilitator that would then allow one or more vendors access to let them price a quote.

Collected data may need to be protected from tampering by a user. When necessary, this could be achieved in a number of possible ways. The data could be stored as encoded with a password known only to the facilitator. It could be stored in duplicate, one copy unencoded and available for the user to read and even edit, although alerts or instructions could be provided to warn user that any changes made to the data would invalidate it for use in any considerations of insurance premiums or validity of warranties. The other copy encoded with a password. A facilitator would be able to both read the encoded version and also see if the open version was altered. Another method of making sure that the presence of any data editing can be easily verified by the facilitator is to save the data in open text format and then for each data part, save a checksum and optionally some file metadata, encoded with a password. Then any change in the saved data could be determined by the facilitator who would have the password to the encoded checksum.

Although the invention has been described with respect to various embodiments, it should be recognized that the invention comprises the novel and non-obvious claims supported by this disclosure.

We claim:

1. A method and system provided by a facilitator, to enable a user to arrange a transaction with a vendor of services or products, said method and system comprising:
an agreement, between the facilitator and the vendor, for the vendor to sell a product or a service to the user, using a computer system comprising components, said agreement providing for compensation by the vendor to the facilitator, based on the vendor's transaction with the user;
a computer system, enabling a user or previously authorized automatic process, to initiate a transaction process, while a connection to the internet is not available.

2. The methods and system of claim 1, wherein a user can deliver the initiated transaction on portable media to the facilitator by any means.

3. The methods and system of claim 1, the computer system further executing an automatic connection to the internet when a connection becomes available and continuing the initiated transaction process.

4. The methods and system of claim 1 wherein availability of a connection to the internet is automatically sensed by the computer system.

5. The methods and system of claim 3 wherein the computer system completes the transaction automatically.

6. The methods and system of claim 1 wherein the computer system displays the status of transactions on a display device.

7. The methods and system of claim 1 wherein some of the computer system components are located on a vessel.

8. The methods and system of claim 7 wherein the computer system comprises a web accessible server.

9. The methods and system of claim 1 wherein the computer system checks each order entry for possible errors.

10. Methods and systems of using computer hardware and software on a vessel, for the purpose of recording maintenance and usage of the vessel and equipment, the methods comprising:
saving a maintenance and usage record in a LogFile;
establishing an agreement between a facilitator and an insurer for the use of the LogFile;
not requiring a connection to a network outside of the vessel's local area network, when saving the vessel maintenance and usage record;
a method for detecting unauthorized changes of the vessel maintenance and usage record in the LogFile.

11. The methods of claim 10 wherein data comprising the vessel maintenance and usage record is uploaded from a monitoring device to a computer.

12. The methods of claim 10 wherein information in the LogFile is verified using independent sources.

13. The methods of claim 11 wherein information in the LogFile is correlated with information from independent sources.

14. The methods of claim 11 further conveying the information in the LogFile to the facilitator.

15. The methods of claim 11 further providing the facilitator or insurer access to information in the LogFile.

16. Methods and systems enabling a user of equipment to document compliance with the equipment warrantor's maintenance requirements, said methods comprising:
creating an electronic maintenance record of the equipment;
automatically creating an entry, in the electronic maintenance record, of a performed maintenance action;
protecting validity of the entry in the electronic maintenance record;
conveying relevant information from the electronic maintenance record, to the warrantor.

17. The methods of claim 16 wherein the collection of the maintenance record comprises an upload of data from an electronic monitoring device to a computer.

18. The methods of claim 17 further negotiating an agreement between a facilitator and the warrantor to accept maintenance records which show compliance with maintenance requirements, as bona-fide proof of compliant maintenance.

19. The methods of claim 16 further negotiating an agreement between a facilitator and the warrantor to accept maintenance records which show compliance with maintenance requirements, as bona-fide proof of compliant maintenance.

20. A method and system provided by a facilitator, to enable a user to arrange a transaction with a vendor of services or products, said method and system comprising:
a computer system which communicates to the user the occurrence of an event needing a commerce transaction;
a computer system, enabling a user or previously authorized automatic process, to initiate the transaction, while a connection to the internet is not available.

21. A method and system, provided by a facilitator, enabling a user to arrange automatic notification of a vendor of the user's intended order.

22. The method of claim 21 wherein the automatic notification is by means selected from a list consisting of: an email message, a text message, any push technology, interactive voice response, using a connection to the internet.
